(19) United States
(12) Patent Application Publication
(10) Pub. No.: US 2007/0253687 A1
(43) Pub. Date: Nov. 1, 2007

(54) WAX DISPENSER FOR HOT WAXING APPLICATIONS

(75) Inventors: Megan Palkie, Ventura, CA (US); Mia Palkie, Eugene, OR (US)

Correspondence Address: SNELL & WILMER L.L.P. (Main), 400 EAST VAN BUREN, ONE ARIZONA CENTER, PHOENIX, AZ, 85004-2202, US

(73) Assignee: WAX FIGURES, INC., Eugene, OR (US)

(21) Appl. No.: 11/760,918

(22) Filed: Jun. 11, 2007

Related U.S. Application Data
(63) Continuation of application No. 10/758,141, filed on Jan. 15, 2004, now abandoned.

(51) Int. Cl. F24H 1/18; B67D 5/62

(52) U.S. Cl. 392/441; 392/459; 222/146.5

(57) ABSTRACT

A hot wax dispensing device designed to minimize the risk of cross contamination caused by “double dipping” into a community hot wax pot. This device receives bulk wax, melts the wax, and allows the melted hot wax to collect in a bowl that is not directly accessible by a user. Hot wax is then dispensed in single client portions in a disposable insert for use in depilatory waxing.

### CROSS-REFERENCE TO RELATED APPLICATION

This application is a continuation of U.S. patent application Ser. No. 10/758,141 entitled “Wax Dispenser For Hot Wax Application”, filed on Jan. 15, 2004, and incorporated herein by reference.

### FIELD OF INVENTION

This invention relates to devices for heating and dispensing hot wax. More specifically, this invention relates to hot wax dispensers that improves the cleanliness and helps prevent the spread of infectious diseases.

### BACKGROUND OF THE INVENTION

A variety of techniques are well known for use in dispensing hot wax in the hair removal process, otherwise known as depilatory waxing. Generally, these prior techniques fail to address the significant risk of spread of infectious diseases caused by cross-contamination between customers by repeated use of an applicator stick and/or use of the same portion of wax for more than one customer.

### SUMMARY OF THE INVENTION

It is desirable to provide a device designed to melt and dispense wax for use in the hair removal process, otherwise known as depilatory waxing. It is particularly desirable to provide such a wax-dispensing device that, if used correctly, will improve the cleanliness of the waxing process and will help reduce the spread of infectious diseases. Moreover, it is desirable that the wax-dispensing device be compatible with standard depilatory wax and that its use not significantly disturb the esthetician's depilatory waxing routine.

Accordingly, it is an object of this invention to provide a device, which melts and dispenses wax for use in depilatory waxing.

It is a further object of this invention to provide a wax-dispensing device that provides a fresh portion of melted wax for each customer.

A still further object of this invention is to provide a wax-dispensing device that melts the wax in a separate heated reservoir.

It is a still further object of this invention to provide a wax-dispensing device that heats the wax in an area that cannot be directly accessed by a user with an applicator stick.

Another object of this invention is to provide a wax-dispensing device that dispenses the melted wax into a disposable cup for application for each customer.

A still further object of this invention is to provide a wax-dispensing device that avoids “double dipping” where an application stick is repeatedly dipped into the hot wax, which is used for multiple customers.

Additional objects, advantages and other novel features of this invention will be set forth in part in the description that follows and in part will become apparent to those of ordinary skill in the art upon examination of the following description and drawings or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described present preferred embodiments of the invention, simply by way of illustration of modes known to the inventor to carry out this invention. As it will be realized, this invention is capable of other different embodiments, and its several details, and specific components. Such modifications can be made without departing from the concept of this invention. Accordingly, these objects, summary, drawings and descriptions should be regarded as illustrative and not as restrictive.

### BRIEF DESCRIPTION OF THE DRAWINGS

The accompanying drawings incorporated in and forming a part of the specification, illustrate the present preferred embodiment of the invention. Some, although not all alternative embodiments are described in the following description. In the drawings:

FIG. 1 is a perspective view of the present embodiment of the wax dispenser of this invention.

FIG. 2 is a top view of the present embodiment of the wax dispenser of this invention.

FIG. 3 is a front view of the present embodiment of the wax dispenser of this invention.

FIG. 4 is a side/section view of the present embodiment of the wax dispenser of this invention.

FIG. 5 is a detailed component assembly view of the present embodiment of the wax dispenser of this invention.

FIG. 6 is the electrical wiring diagram for the present embodiment of this invention.

Reference will now be made in detail of the present preferred embodiment of the invention, an example of which is illustrated in the accompanying drawings.

### DETAILED DESCRIPTION

This invention, referred to herein as a wax dispenser, is a device for melting and dispensing wax for use in the hair removal process, otherwise known as depilatory waxing. This wax dispenser is designed to provide a portion of hot wax, of selectable quantity, for each individual client, thereby minimizing the risk of client-to-client cross contamination.

Prior to this invention a typical depilatory waxing procedure involved heating a significant quantity of wax to a temperature of between 120° F. to 140° F. in a pot similar to a crock-pot. The amount of hot wax that is thus prepared is generally sufficient for a number of clients and in kept in a communal pot, where it is kept sufficiently hot to remain melted. A wooden stick (similar to a tongue depressor or a Popsicle stick) is dipped into the hot wax and applied to the client's skin. Although illegal in many jurisdictions and certainly not best practice, it is a common practice to use and reuse the same stick for second, third and continuous applications, until the desired areas of the client's body are free of hair. This process is referred to in the trade as “double dipping.” While the esthetician may not reuse a stick with multiple clients, the process of “double dipping” serves to transfer from the client hair and in some instances fluids from the clients back to the communal pot. Since hot wax is an excellent breading and/or maintenance ground for germs and viruses, the “double dipping” technique common in the trade have been shown to increase the likelihood of cross-contamination of serious infections diseases and maladies. A variety of approaches have been proposed to deal with this cross contamination problem. The most common of which is use of roll-on waxing systems. However, this roll-on approach has been unsuccessful at solving this problem because (1) it allows wax that has touched a client's body to re-enter the roller head thereby contaminating other wax; (2) it is inconvenient because it changes the esthetician's routine and dictates the type or brand of wax that can be used; and (3) it is expensive compared to the more traditional stick application approach. Attempts by esthetician's to control costs have led some estheticians to reuse roller heads for multiple clients, thereby exasperating the cross contamination problem.

This hot wax dispenser addresses this problem directly. Cross contamination is eliminated by eliminating access to the communal pot of wax. Each client receives wax from a disposable cup containing only wax for their use. The esthetician may double dip into the client's disposable cup because, so long as a new disposable liner is used for each client, there is no risk of contaminating the wax used for subsequent clients. This wax dispenser does not require the esthetician to change their routine in any significant manner. It does, however, avoid cross contamination further by eliminating access to the wax to be used for subsequent clients. This wax dispenser is designed and adapted to accommodate most if not all types and brands of depilatory wax, whether in bead, brick or can form. Again, one of the most important features of this invention is that it provides an individual client sized disposable cup of wax, while removing access to the heated reservoir of hot wax used for subsequent clients, and thereby minimizing the cross-contamination problem caused by “double dipping” in depilatory waxing.

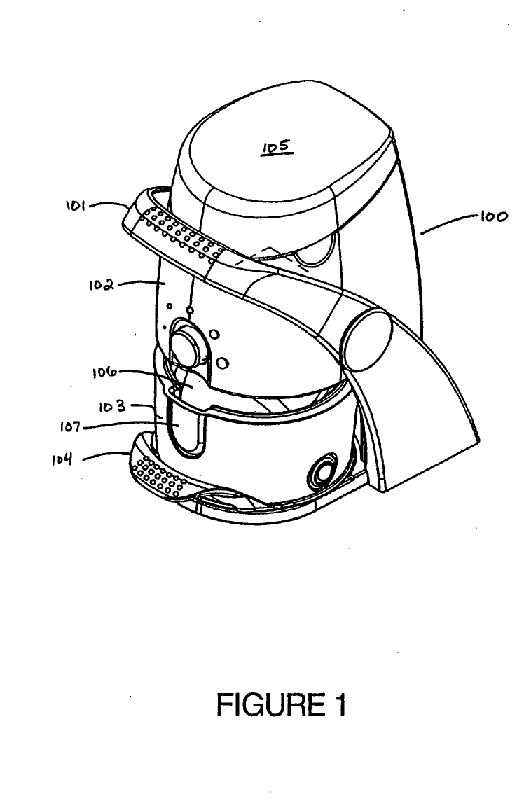

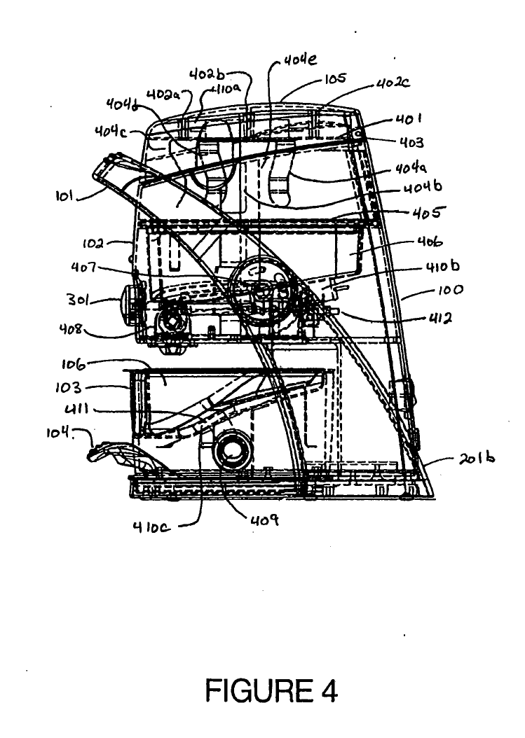

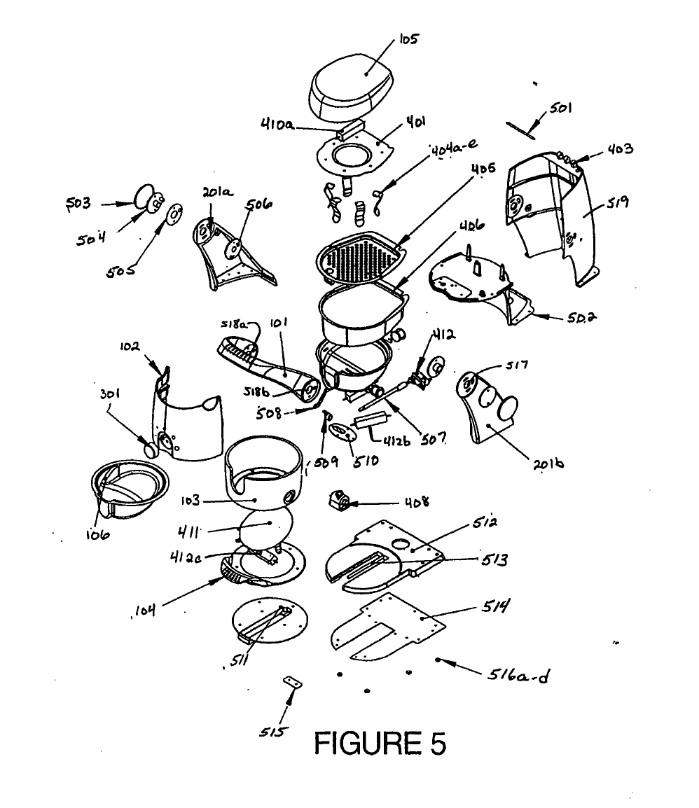

FIG. 1 shows a perspective view of the present embodiment of the wax dispenser 100 of this invention. A body portion 102 is provided, within which is the wax retainer, the heater assembly and the dispensing assembly. A handle 101 is provided for activating the dispensing assembly, thereby releasing melted wax to the cup 103 with its insert 106. A cup handle 104 is provided to facilitate extraction of the cup 103. Although the cup 103 is generally not removed during operation and wax can be dispensed with the cup 103 in either the in or the out position. In either situation, the insert 106 preferably stays in the heated area of the cup 103. A window 107 is provided in the cup 103 to permit a user to see the wax as it flows into the cup 103 or its insert 106 and to insure that the cup 103 does not hold wax without an insert 106 in place. A lid 105 is provided to allow access to the wax retainer. It is worth noting, however, that the lid does not provide access to melted hot wax because the wax in the retainer as it melts flows through a grate to a reservoir or bulk-heating bowl within the body portion 102. The grate insures that a user cannot reach hot melted wax in the bulk-heating bowl through the lid. These internal components are shown in more detail proximate to their assembly in FIGS. 4 and 5.

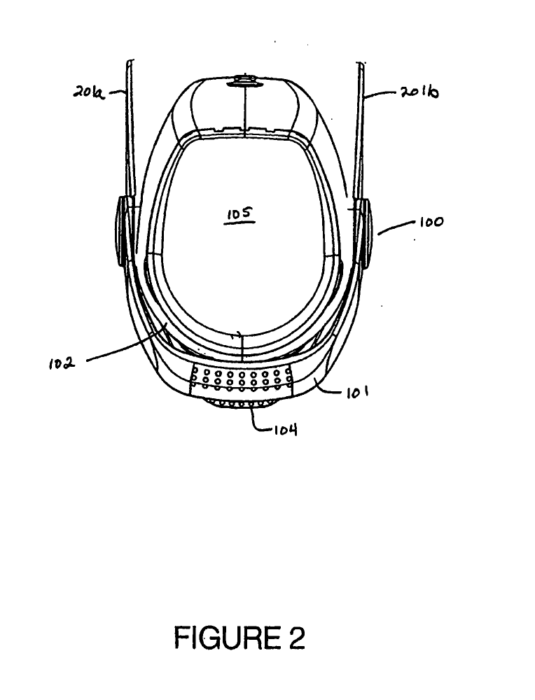

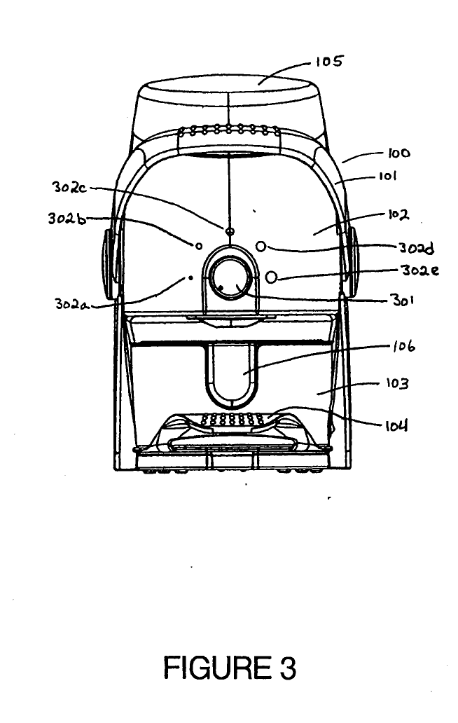

FIG. 2 shows a top view of the present embodiment of the wax dispenser 100 of this invention. This view shows the wax dispenser 100 with the support legs 201a and b attached to the body portion 102, as an extension of the handle 101. FIG. 3 shows a front view of the present embodiment of the wax dispenser 100 of this invention. This view provides additional detail of the heat selection knob 301 and its various setting locations 302a, b, c, d, and e, which in the present embodiment are used as a visual guide to a smooth turn heat selection knob, on the front of the body portion 102. In the present embodiment, by adjusting the knob in a clock-wise direction the temperature of the wax in the bulk heating bowl is increased.

FIG. 4 shows a side/section view of the present embodiment of the wax dispenser 100 of this invention. This view is a section view taken from the side to show the various components in a fully assembled configuration. Under the lid 105 is heat conducting plate 401. The can or other receptacle holding the wax is positioned upside-down on the grate 405. The heat conducting plate 401 is a metal plate which conducts heat from the heater 410a in the lid 105 to the wax containing can. As the wax melts it flows through the grate 405. While in the present embodiment the wax is provided in a can, in alternative embodiments, the wax may be simply placed on the grate directly. The wax may be in the form of a brick, beads or the like. In the present embodiment, the heat conducting plate 401 is fixed to the lid 105 by a number of screws 402a, b, and c so that with the lid 105 flipped open on its hinge 403 the heat conducting plate 401 can receive a can or other bulk wax holding receptacle. When the lid 105 is closed the top of the can is then reversed so that the melted wax will flow freely out of the can down into the interior of the body portion 102. Attached to the heat conducting plate 401 can be a number of spring clips 404a-e for frictionally holding the can in place. In one present alternative embodiment these spring clips 404a-e are not provided and the wax or wax container simply rests directly on the grate 405. Immediately below the clips 404a-c and the can when placed below the heat conducting plate 401 is the grate 405. The grate 405 is provided with a number of openings, as shown in FIG. 5, sufficient to allow the melted wax to flow through the grate 405 to the bulk heating bowl 406 below the grate 405. A valve 408 is attached to the bottom of the bulk-heating bowl 406 is connected 407 to the handle 101. When the handle 101 is pressed, the interior of the valve is turned permitted the melted wax to flow through a valve 408 to the insert 106 in the cup 103. By pulling on the cup handle 104, the cup 103 assembly 409 is brought forward permitting the user to remove the insert 106, now containing hot wax for use on a single client. The cup 103 assembly 409 can be in either the in or the out position when dispensing wax. The insert 106 stays in the heated area of the cup 103 while the client is being waxed. The insert 106 is disposed of once the client waxing is completed. Typically, although not necessarily, the client waxing is performed with the cup 103 in an out position and the insert 106 still in the cup 103. Several heating elements 410a, b, and c are provided. A first heating element 410a is located above the heat conducting plate 401. Since, typically the heat conducting plate 401 and the clips 402a-e, if used, are made of good heat conducting metal, the heat from this first heating element 410a is conducted to the can containing the bulk wax for melting this wax. A second heating element 41b is located under the under the bulk heating bowl 406 for keeping the melted wax in a liquid state. A third heating element 410c is located under the cup plate 411, which supports the cup 103, for keeping the dispensed wax in the disposable insert melted. Each of the heating elements 110a, b, and c controlled by the selection knob 301, limited by a thermostatic switch 412 provided to avoid overheating for safety purposes.

FIG. 5 shows a detailed component assembly view of the present embodiment of the wax dispenser 100 of this invention. Each of these components shown is typically assembled as shown using small screws, bolts, pins and the like. The cup 103 is presently made of abs plastic. In its present embodiment is approximately 3 inches in height and 5.5 inches in diameter and has five screw holes for fixing the cup 103 to the cup plate 411. The insert 106 is sized to fit within the cup 103 and is approximately 5.2 inches in diameter and 1.9 inches at it highest point. Presently the insert 106 is made of tinted clear polycarbonate. The cup handle 104 is presently made of plastic, although in alternative embodiments cast aluminum or similar material can be substituted without departing from the concept of this invention, and is 5.75 inches in diameter with a grip portion height of approximately 1.1 inches. The cup handle 104 is provided with five screw holes for assembly. The bulk-heating bowl 406 is presently made of aluminum and is approximately 5.6 inches in width, 6.2 inches in length and 2.2 inches in height. The bulk-heating bowl 406 is provided with an opening (not shown) on the bottom toward the front for release of melted wax. The valve 408 is presently cast brass with an internal rotatable portion having an opening which when aligned with the inlet port allows the melted wax to flow from the opening in the bulk heating bowl 406 through the valve inlet, through the internal rotatable portion to the valve outlet and to the insert 106. Four screw holes are provides for assembly. The support legs 201a and b are presently made of case aluminum and are approximately 6 inches in height and 3.2 inches in width. Screw holes are provided for assembly and an opening 517 is provided for mounting the handle 101. A switch link shaft, presently made of aluminum, 507 connects the knob 301 to the thermostat 412b. The handle 101 is presently made of case aluminum and is provided with a hole 518a and b on each end for connection to the support legs 201a,b. Typically, a spring is linked to the handle 101 to keep the valve in a normally closed position. The lid 105 is presently made of abs plastic and is approximately 5.5 inches in width and 6.5 inches in length. The lid 105 is provided with six screw holes for assembly. A valve-coupling lever 509, presently made of aluminum is provided for connecting valve 408 to the valve linkage 508. The valve linkage 508 is presently made of 12 gage steel. A wax nozzle 510 is provided presently in abs plastic to provide hot wax flow control. A handle cap 503 is provided for each end of the handle 101. Presently the handle cap is made of cast aluminum. The base body portion 102 is presently made of abs plastic and is adapted to fit about the front upper part of the wax dispenser 100. The base 502 provides the support structure for the bulk-heating bowl 406. The base 502 is presently made of abs plastic and has a number of screw holes for assembly purposes. The rear portion 519 is presently made of abs plastic and is fitted with the hinge 403, which with a hinge pin 501, presently a 0.125 diameter steel rod, secures the lid 105. Holes in the sides of the rear portion 519 are adapted to receive the connection to the ends of the arm 101. Screw holes in the rear portion 519 provide the means with screws of attaching the rear portion to the base 502. An outer handle axle 504 is provided for each end of the handle 101 and is presently made of abs plastic. An inner axle handle 506 is provided for each end of the handle 101 and is presently made of abs plastic. A washer 505 is provided for each handle axle, presently made of nylon. The grate 405 is presently made of aluminum and is provided with a number of 0.25-inch holes and a single 0.625-inch diameter hole. The clips 404a-e, although not necessary for the present embodiment, can be made of 24-gage steel. The heat conducting plate 401 is presently made of 18-gage steel and is provided with six screw holes for assembly. The knob 301 is presently made of abs plastic and is adapted to receive the link shaft 507. A base extension 512, presently made of cast aluminum, is provides with six screw holes and nine feet holes. A cup housing bottom 511, presently made of cast aluminum, is adapted for supporting the cup assembly 411 and is provides with seven screw holes for assembly purposes. A cup slider tab 515, presently made of 13-gage steel, is provided to fit in the cup-housing bottom. The cup plate 411, presently made of 24-gage steel is provides with five mounting fixtures for fastening in place. A base cover 514 made of 18-gage steel is provided with screw and foot holes. The electrical wire (not shown) connecting AC power to the resistor heaters 412a, b, and c and carrying control signals from the thermostatic switches are held within a stainless steel tube.

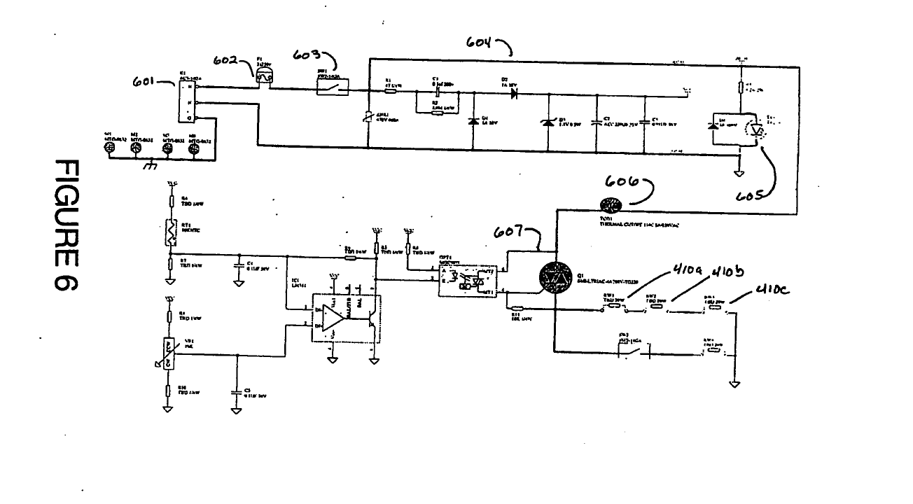

FIG. 6 shows the electrical wiring diagram of the wax dispenser 100 of this invention. This diagram shows the power connection 601, fuse 602 and switch 603 in series with a power smoothing circuit 604 and a power indicator LED 605. A thermal cutout 606 is provided in series with the drive circuit 607 for the heating element resistors 410a, b, and c.

It is to be understood that the above-described embodiments and examples are merely illustrative of numerous and varied other embodiments and applications which may constitute applications of the principles of the invention. These above-described embodiments are provided to teach the present best mode of the invention only, and should not be interpreted to limit the scope of the claims. Such other embodiments, may use somewhat different steps and routines which may be readily devised by those skilled in the art without departing from the spirit or scope of this invention and it is our intent that they are deemed to be within the scope of this invention.

1. A hot wax dispenser, comprising:
at least one bowl configured to hold wax;
at least one heating element coupled to said bowl configured to heat said bowl and said wax held in said bowl, until said wax is flowable;
at least one insert in fluid communication with said bowl configured to collect said flowable wax as it flows from said bowl into said insert; and
at least one cup configured to hold and assist in transporting said insert, wherein said insert can be removed from said cup.

2. The hot wax dispenser of claim 1, further comprising a valve coupled to said at least one bowl, wherein said valve is configured to control the flow of said flowable wax.

3. The hot wax dispenser of claim 1, further comprising a handle coupled to said valve configured to control said valve thereby controlling the flow of said flowable wax.

4. The hot wax dispenser of claim 1, further comprising a grate.

5. The hot wax dispenser of claim 1, further comprising a body coupled to said at least one bowl and said at least one heating element, wherein said body further comprises a base, a front body portion, a rear portion and a base portion.

6. The hot wax dispenser of claim 5, further comprising at least one spring clip coupled to said body, wherein in said at least one spring clip is located above said at least one bowl and is configure to hold said wax.

7. The hot wax dispenser of claim 6, further comprising at least one additional heating element coupled to said at least one spring clip, wherein said at least one additional heating element is configured to heat said wax.

8. The hot wax dispenser of claim 1, further comprising at least one thermal plate for holding said at least one cup.

9. The hot wax dispenser of claim 6, further comprising at least one additional heating element coupled to said at least one thermal plate, wherein said at least one additional heating element is configured to heat said flowable wax.

10. A method for preparing, dispensing, and transporting hot wax comprising:
placing wax into at least one bowl configured to hold said wax, wherein said bowl is coupled to at least one heating element configured to heat said bowl and said wax held in said bowl, until said wax is flowable;
opening a valve coupled to said bowl configured to dispense said flowable was to flow from said bowl into at least one insert held inside at least one cup configured to assist in transporting said insert, wherein said flowable wax cannot flow form said bowl into said insert when said valve is closed;
closing said valve once said insert is filled with said flowable wax away from said bowl and said heating element.

11. The method of claim 10 further comprising;
removing said insert from said cup;
inserting a different insert into said cup;
placing said cup with said different insert under said bowl and said heating element; and
opening said valve coupled to said bowl to dispense more flowable wax into said different insert said cup.

12. The method of claim 10, wherein said step of opening said valve involves activating a handle configured to control said valve thereby controlling the flow of said flowable wax.

13. A method for preparing, dispensing, and transporting hot wax comprising:
placing wax into a spring clip, wherein said spring clip is configured to hold wax and has a first heating element coupled to said spring clip to heat said wax, until said wax is flowable
activating said first heating element such that said flowable wax collects in at least one bowl configured to hold said wax, wherein said bowl is coupled to at least one heating element configured to heat said bowl and said wax held in said bowl;
opening a valve coupled to said bowl configured to dispense said flowable was to flow from said bowl into at least one insert held inside at least one cup configured to assist in transporting said insert, wherein said flowable wax cannot flow form said bowl into said insert when said valve is closed;
closing said valve once said insert is filled with said flowable wax away from said bowl and said heating element.
